(19) United States
(12) Patent Application Publication
(10) Pub. No.: US 2019/0362271 A1
(43) Pub. Date: Nov. 28, 2019

(54) METHOD AND SYSTEM OF MANAGING DATA OF AN ENTITY

(71) Applicant: Wipro Limited, Bangalore (IN)

(72) Inventor: Madhukar Kambadahalli Puttasetty, Cary, NC (US)

(73) Assignee: Wipro Limited

(21) Appl. No.: 15/988,569

(22) Filed: May 24, 2018

(51) Int. Cl. G06N 99/00; G06F 17/30; G06N 5/04

(52) U.S. Cl. CPC G06N 99/005; G06N 5/04; G06F 17/30598

(57) ABSTRACT

The data management system receives data associated with an entity from data source. The data comprises a current data and a reference data. A category of current data is predicted to be one of duplicate data and non-duplicate data, with respect to reference data, using a plurality of Supervised Machine Learning (SML) classifiers, where each of the plurality of SML classifiers predicts category of the data individually. The data management system generates a confidence factor of the duplicate data category and the non-duplicate data category based on the prediction of each of the plurality of SML classifiers and thereafter determines current data to be one of, duplicate data and non-duplicate data based on confidence factor to manage data of entity.

### TECHNICAL FIELD

The present subject matter is related in general to data management, more particularly, but not exclusively to method and system for managing data of an entity.

### BACKGROUND

Over years, with development and advance in technology, an unprecedented rise in data has been observed. The unprecedented rise in volume and variety of data has necessitated for better data management practices. Today, every organization hugely runs and depends on master data of the organization. The master data signifies business objects of the organization which may be agreed on and shared across the organization. Particularly, the master data may include a static reference data, a transactional data, an unstructured data, an analytical data, a hierarchical data and meta data associated with the organization. Generally, the master data is often strewn across many channels in the organization, invariably containing duplicates and conflicting data. Today, most of the organization uses Master Data Management (MDM) to manage the data in the organization. A master data management tool may be used to support data management by capturing master data from multiple sources, identifying duplicates or different versions, removing duplicates, standardizing data, and integrating rules to eliminate incorrect data from entering the system in order to create an authoritative source of master data.

Presence of duplicate records is unwanted, and may lead to wastage, degrade customer service, and may obstruct customer-tracking and data-collection efforts. Several existing conventional systems have an ability to identify identical records and eliminate duplicates. However, such conventional systems may come across a struggle when the duplicate records are not identical to one another. In such situations, it may be difficult to determine which data is correct, particularly when data elements in various records are inconsistent with one another. Further, various MDM systems may mark potential matches between data, posing difficulty to resolve due to complexity and various flavours of the data. Additionally, the existing system may require a human expert each time to review and resolve the complexity during data management. Manual, or human review of potential merges is inevitable in most data management implementations. Some implementations require an army of data experts to resolve the records. Such situation incurs considerable cost to the organization and introduces delay in making merged data available to the organization due to involvement of human factor. Additionally, the manual records may be held hostage till a data expert reviews and resolves such records.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure may relate to a method for managing data of an entity. The method comprises receiving data associated with an entity from a data source. The data comprises a current data and a reference data. The method comprising predicting a category of the current data to be one of, duplicate data and non-duplicate data, with respect to the reference data, using a plurality of Supervised Machine Learning (SML) classifiers. The plurality of SML classifiers predicts the category of the data individually. The method comprises generating a confidence factor of the duplicate data category and the non-duplicate data category based on the prediction of each of the plurality of SML classifiers and determining the current data to be one of, the duplicate data and the non-duplicate data based on the confidence factor to manage the data of the entity.

In an embodiment, the present disclosure may relate to a data management system for managing data of an entity. The data management system may comprise a processor and a memory communicatively coupled to the processor, where the memory stores processor executable instructions, which, on execution, may cause the data management system to receive data associated with an entity from a data source. The data comprises a current data and a reference data. The data management system predicts a category of the current data to be one of, duplicate data and non-duplicate data, with respect to the reference data, using a plurality of Supervised Machine Learning (SML) classifiers. The plurality of SML classifiers predicts the category of the data individually. The data management system generates a confidence factor of the duplicate data category and the non-duplicate data category based on the prediction of each of the plurality of SML classifiers and determines the current data to be one of, the duplicate data and the non-duplicate data based on the confidence factor to manage the data of the entity.

In an embodiment, the present disclosure relates to a non-transitory computer readable medium including instructions stored thereon that when processed by at least one processor may cause a data management system to receive data associated with an entity from a data source. The data comprises a current data and a reference data. The instruction causes the processor to predict a category of the current data to be one of, duplicate data and non-duplicate data, with respect to the reference data, using a plurality of Supervised Machine Learning (SML) classifiers. The plurality of SML classifiers predicts the category of the data individually. The instructions causes the processor to generate a confidence factor of the duplicate data category and the non-duplicate data category based on the prediction of each of the plurality of SML classifiers and determine the current data to be one of, the duplicate data and the non-duplicate data based on the confidence factor to manage the data of the entity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for managing data of an entity in accordance with some embodiments of the present disclosure;

FIG. 2 shows a detailed block diagram of a data management system in accordance with some embodiments of the present disclosure;

FIG. 3 show an exemplary representation for imaging data of an entity in accordance with some embodiments of the present disclosure;

FIG. 4 illustrates a flowchart showing a method for managing data of an entity in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure relate to a method and a data management system for managing an entity. In an embodiment, the entity may refer to an organizational structure having goals, processes, and record. The data management system may receive data to be checked with reference data for determining duplicity. The data management system may make prediction regarding the data to be duplicate and non-duplicate using a plurality of trained machine learning classifiers. The plurality of trained machine learning classifiers may make the prediction individually. After the prediction, the data management system may check a confidence factor of the prediction for each of the plurality of machine learning classifiers and may determine the data to be one or duplicate and non-duplicate based on the confidence factor. The present disclosure eliminates manual efforts by data stewards significantly.

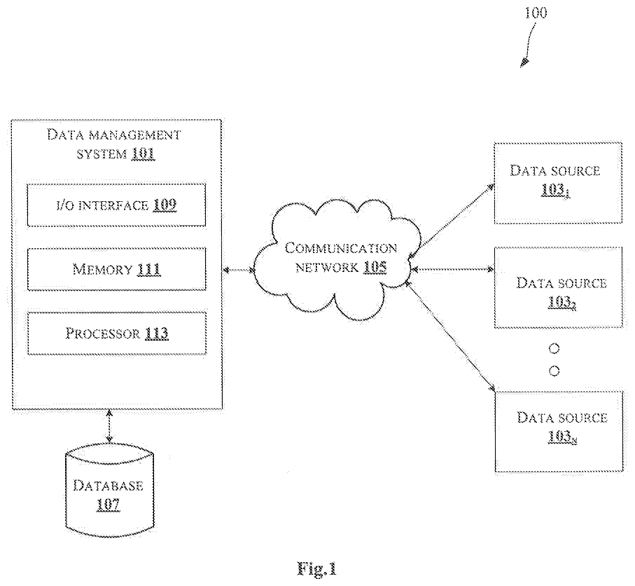

FIG. 1 illustrates an exemplary environment for managing data of an entity in accordance with some embodiments of the present disclosure.

As shown in FIG. 1, an environment 100 comprises a data management system 101 connected through a communication network 105 to a data source 103₁, a data source 103₂, . . . and a data source 103^{N} (collectively referred as plurality of data sources 103). The data management system 101 is connected to a database 107. The data sources 103 may be associated with an entity. In an embodiment, the entity may refer to an organizational structure having goals, processes, and record. For instance, the entity may comprise, an enterprise, an organization, a government body, public and private sector, and the like. A person skilled in the art would understand that any other entity, not mentioned explicitly, may also be used in the present disclosure. Further, the communication network 105 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like.

Generally, data present across any entity may be associated with many inconsistencies and duplicity. To mange the data across the entity, the data management system 101 may determine duplicity of the data of the entity and manage the data. In one embodiment, the data management system 101 may include, but is not limited to, a laptop, a desktop computer, a Personal Digital Assistant (PDA), a notebook, a smartphone, a tablet, a server, and any other computing devices. A person skilled in the art would understand that, any other devices, not mentioned explicitly, may also be used as the data management system 101 in the present disclosure. The data management system 101 may comprise an I/O interface 109, a memory 111 and a processor 113. In another implementation, the data management system 101 may be configured as a standalone device or may be integrated with the computing systems. Initially, the data management system 101 may train a plurality of Supervised Machine Learning (SML) classifiers based on a plurality of master datasets associated with the entity and analysed by one or more data experts as duplicate and non-duplicate. Once the plurality of SML classifiers are trained, the data management system 101 may evaluate the plurality of trained SML classifiers based on one or more metrics and data exploration technique. In an embodiment, the one or more metrics comprises accuracy metrics, precision metrics, recall metrics and F1-score metric which is a combination of precision and recall metrics. In real-time, the data management system 101 may receive the data associated with the entity from a data source of the plurality of data sources 103. The data comprises current data and reference data. In an embodiment, the current data is data suspected to be duplicate with respect to the reference data, by the entity associated with the data. The data management system 101 may convert a format of the data to a predefined format of the plurality of Supervised Machine Learning (SML) classifiers. For example, the data may be converted from text format to numeric format. Further, the data management system 101 uses the plurality of SML classifiers to predict a category of the current data to be, one of duplicate data and non-duplicate data with respect to the reference data. In an embodiment, the duplicity may be checked with respect to each field in the current data with respective field in the reference data. The category for the current data may be predicted by each of the plurality of SML classifiers individually. Further, the data management system 101 may generate a confidence factor for the duplicate data category and the non-duplicate data category based on the prediction of each of the plurality of SML classifiers. In an embodiment, the confidence factor for the duplicate category may be total number of the SML classifiers with the prediction of duplicate data category. Similarly, the confidence factor for the non-duplicate category may be total number of the SML classifiers with the prediction of non-duplicate category. Thereafter, the data management system 101 may determine the current data to be one of, the duplicate data and the non-duplicate data based on the confidence factor to manage the data of the entity. In one embodiment, the current data may be determined to be duplicate data, when the confidence factor of the duplicate data category is greater than the confidence factor of the non-duplicate data category. In another embodiment, the current data is determined to be non-duplicate data, when the confidence factor of the non-duplicate data category is greater than the confidence factor of the duplicate data category. In an embodiment, the data management system 101 may facilitate learning for one or more SML classifiers of the plurality of SML classifiers, associated with the category of the data having a minimum confidence factor. In an embodiment, the data management system 101 may provide instructions to a system based on the determination of the current data to be one of the duplicate data and the non-duplicate data to manage redundant data.

The I/O interface 109 may be configured to receive the data from the data source of the plurality of data sources 103. The information received from the I/O interface 109 may be stored in a memory 111. The memory 111 may be communicatively coupled to the processor 113 of the data management system 101. The memory 111 may also store processor instructions which may cause the processor 113 to execute the instructions for managing data of the entity.

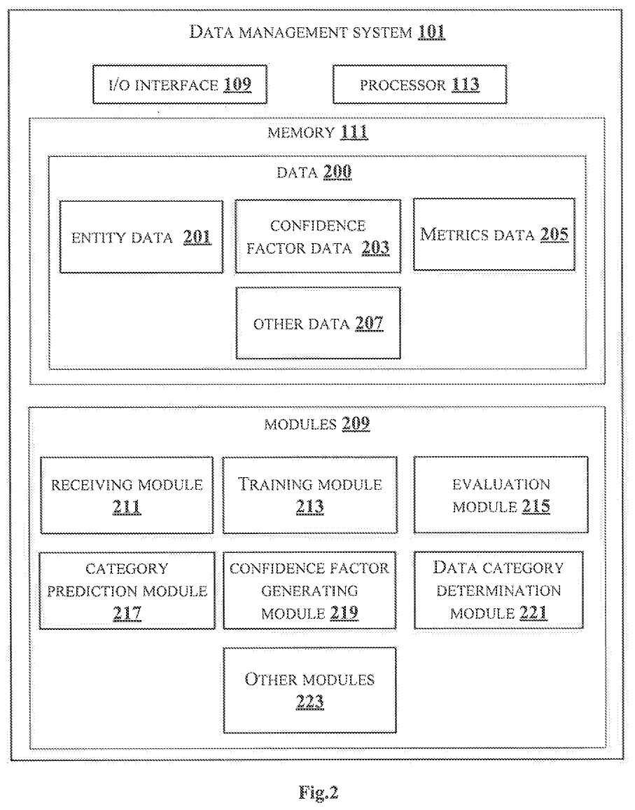

FIG. 2 shows a detailed block diagram of a data management system in accordance with some embodiments of the present disclosure.

Data 200 and one or more modules 209 of the data management system 101 are described herein in detail. In an embodiment, the data 200 may include entity data 201, confidence factor data 203, metrics data 205 and other data 207.

The entity data 201 may comprise the data received from the data source of the plurality of data sources 103 for determining duplicity. In an embodiment, the entity data 201 may comprise the plurality of training master datasets. In one embodiment, the data received from the data source may be one of, customer data files, a plurality of product data files, a plurality of employee data files, a plurality of location data files and the like. A person skilled in the art would understand that any other type of data, not mentioned explicitly, may also be included in the present disclosure.

The confidence factor data 203 may comprise the confidence factor generated for the duplicate data category and for the non-duplicate data category. In an embodiment, the confidence factor data 205 may comprise two confidence factors, one for the duplicate data category and another for the non-duplicate data category. In an embodiment, the confidence factor may be evaluated in terms of percentage. A person skilled in the art would understand that the confidence factor may be evaluated in any other form, not mentioned explicitly in the present disclosure.

The metrics data 205 may comprise details of the one or more metrics applied for the evaluation of the plurality of SML classifiers after training. The details of the one or more metrics may comprise type of the metrics applied and result of each of the metrics. In an embodiment, the one or more metrics may comprise the accuracy metrics, the precision metrics, the recall metrics and the F1-score metric which is a combination of precision and recall metrics.

The other data 207 may store data, including temporary data and temporary files, generated by modules 209 for performing the various functions of the data management system 101.

In an embodiment, the data 200 in the memory Ill are processed by the one or more modules 209 of the data management system 101. As used herein, the term module refers to an Application Specific Integrated Circuit (ASIC), an electronic circuit, a field-programmable gate arrays (FPGA), Programmable System-on-Chip (PSoC), a combinational logic circuit, and/or other suitable components that provide the described functionality. The said modules 209 when configured with the functionality defined in the present disclosure will result in a novel hardware.

In one implementation, the one or more modules 209 may include, but are not limited to a receiving module 211, a training module 213, an evaluation module 215, a category prediction module 217, a confidence factor generation module 219 and a data category determination module 221. The one or more modules 209 may also include other modules 223 to perform various miscellaneous functionalities of the data management system 101. In an embodiment, the other modules 223 may include a format conversation module, a learning module and an instruction providing module. The format conversion module may be utilized to convert the format of the data received from the plurality of data sources 103 to the predefined format of the plurality of SML classifiers. The learning module may be used to facilitate learning for the one or more SML classifiers of the plurality of SML classifiers, which may be associated with the category of the data with the minimum confidence factor. The instruction providing module may provide instructions to a system based on determination of the current data to be one of duplicate data and the non-duplicate data to manage redundant data.

The receiving module 211 may receive the data from the data source of the plurality of data sources 103 associated with the entity. The user input may comprise the current data suspected to be duplicate and the reference data with which the current data may be checked for duplicity.

The training module 213 may train the plurality of SML classifiers based on the plurality of master datasets analysed by one or more data experts as duplicate and non-duplicate. For example, consider below two tables, Table.1a and Table.1b.

TABLE 1a

| First name | Last name | Address | City | State |
|---|---|---|---|---|
| Curt | Boyce | 123 main street | Chap. Hill | NC |
| Curtis | Boyce | 123 main St. | Chapel hill | NC |

TABLE 1b

| First name | Last name | Address | City | State |
|---|---|---|---|---|
| John | Smith | S Miami Blvd | Cary | NC |
| John | Smith | N Miami Blvd | Cary | NC |

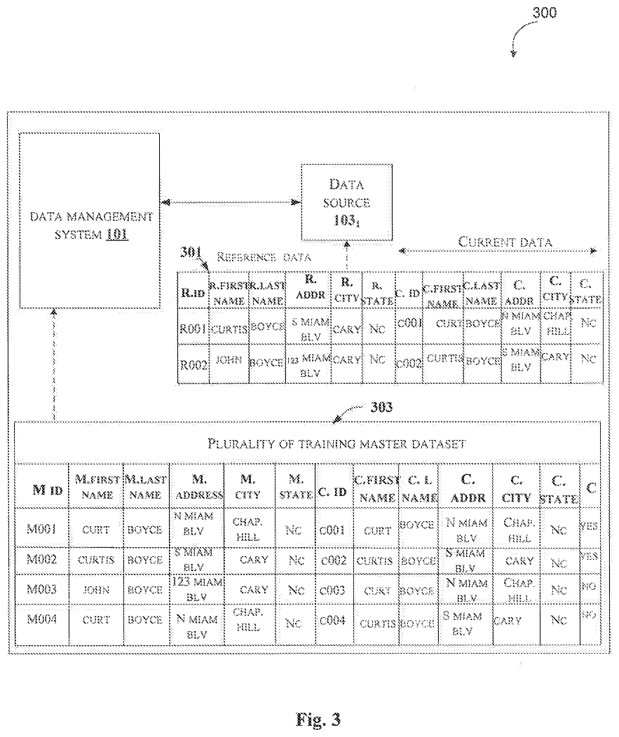

As shown above, the Table.1a and Table.1b, comprises data of employees with conflict data sets. The data of the employees may be initially evaluated by the data experts and labelled as duplicates or not duplicates. The data of the employees reviewed by the data experts are used as input for training the plurality of SML classifiers. For instance, in the table 1a, the record of the employees is termed as duplicates since, Curtis is a short form often called Curt and abbreviating street as St. is very common. In the table.1b, the record of the employees is termed as not duplicates. Although, the record look similar, however, South Miami and North Miami are two different street addresses and there is chance of two different persons with same name staying in each of these addresses. Further, the training module 213 may determine point of similar score and exact match to train the plurality of SML classifiers. An example to determine point of similar score and exact match is provided in FIG. 3.

The evaluation module 215 may evaluate the plurality of trained SML classifiers using the one or more metrics and data exploration technique. The one or more metrics may include the accuracy metric, the precision metric, the recall metric and the and F1-score metric which is a combination of precision and recall metrics. In an embodiment, the accuracy metric may measure how often the plurality of SML classifiers predict the category of the data correctly. The accuracy metric may comprise a true positive, a true negative with equal weight, a false positive and a false negative. The accuracy metrics may be defined as shown in below equation.

$$Accuracy = \frac{TruePositives + FalsePositives}{ dataset size} \qquad ( 1 )$$

The accuracy metric may be used to minimize the false positives and the false negatives to avoid loss of the entity. For example, consider if two identical customer records are falsely categorized as not-duplicates and retained as two different customers in the entity. In such case, suppose a retail company may send out promotional vouchers or coupons to the customer twice since the customer exists as two different records in the entity. Similarly, consider if two customers are unique and are falsely categorized as duplicates and consolidated into one record. In such case, the retail company may fail to send promotional vouchers or coupons to one of them and loose a potential customer. Further, the precision metric is defined as a ratio of true positives to all positives. In an embodiment, the true positives are sets classified as duplicates, and are duplicates. In an embodiment, all positives may be sets classified as duplicates irrespective of whether or not the positives are correctly classified. In an embodiment, the precision metric may be used to determine proportion of conflicting sets that are classified as duplicates and are duplicates. In other words, the precision metric may be used to evaluate the quality of positive classifications made by the plurality of SML classifiers. Equation 2 below define the precision metric.

$$Precision = \frac{True Positives}{TruePositives + FalsePositives} \qquad ( 2 )$$

Further, the recall metric is defined as a ratio of true positives to sum of true positives and false negatives. In an embodiment, the false negatives are sum representing all sets which are duplicate. An equation for calculating the recall metric is defined in equation 3 below. In an embodiment, the recall metric may be used to determine proportion of conflicting sets which are duplicates and are classified as duplicates. In other words, the recall metric may be used to evaluate extent to which the true positives are not missed or overlooked by each of the plurality of SML classifiers.

$$Precision = \frac{True Positives}{TruePositives + FalseNegatives} \qquad ( 3 )$$

Further, the F1-score metric may be defined as a combination of the precision metric and the recall metric. In an embodiment, the F1-score metric is a weighted average or harmonic mean of the precision metric and the recall metrics. An equation for calculating the F1-score metric is defined in equation 4. The F1-score may range from 0 to 1, with 1 being the best possible F1-score.

$$F 1 - Score = 2 * \frac{Precision \text{?} Recall}{Precision + Recall} \\ \text{?} \text{indicates text missing or illegible when filed} \qquad ( 4 )$$

Furthermore, the evaluation module 215 may evaluate the plurality of trained SML classifiers using the data exploration technique. A person skilled in the art would understand that any other technique, not mentioned explicitly, may also be used for evaluating the plurality of trained SML classifiers. In an embodiment, the evaluation module 215 may use data exploratory visualization technique to evaluate the plurality of trained SML classifiers. In the exploratory visualization, a plot may be created to show distribution of the points-of-similar score and exact-match in the data.

The category prediction module 217 may predict the category of the current data received from the receiving module 211 to be one of the duplicate data and the non-duplicate data. The category prediction module 217 may predict the category for the current data with respect to the reference data by using the plurality of trained SML classifiers. Each of the plurality of trained SML classifiers may predict one category for the current data individually. In an embodiment, the plurality of SML classifier may be a combination of any of, a Logistic Regression classifier, a Gaussian Naïve Bayes (GNB) classifier, a Random Forest (RF) classifier, a Linear Support Vector Classification (SVC) classifier, a Support Vector Classification (SVC) classifier, an Ada Boost (AB) classifier, a Decision Tree (DT) classifier, a K Neighbors classifier, a Stochastic Gradient Descent (SGD) classifier, a ridge Classifier, a Passive Aggressive (PA) classifier, an Extra Tree (ET) classifier, a Bagging Classifier Gradient Boosting (BCGB) classifier and an Extra Trees (ET) classifier. A person skilled in the art would understand that any other type of classifier, not mentioned explicitly, may also be included in the present disclosure.

The confidence factor generating module 219 may generate the confidence factor for each of the duplicate data category and the non-duplicate data category based on the prediction of each of the plurality of SML classifiers. In an embodiment, the confidence factor generating module 219 may calculate the total number of SML classifiers who have predicted the category of data to be the duplicate data category and the total number of SML classifiers who have predicted the category of data to be the non-duplicate data category. For example, consider the data management system 101 uses fifteen SML classifiers. Among the fifteen SML classifiers, ten of the SML classifiers may predict the current data to under duplicate data category and five of the SML classifiers may predict the current data to be under non-duplicate data category. In such case, the confidence factor generating module 219 may generate the confidence factor for the duplicate data category to be approximately sixty-six percentage and for the non-duplicate data category to be approximately thirty-three percentage. In an embodiment, the SML classifiers with a minimum confidence factor may be provided with learning by the learning module. For instance, in the above example, the confidence factor for the duplicate data category is sixty-six percentage and for the non-duplicate data category is thirty-three percentage. In such case, the SML classifiers with the predication of non-duplicate category and corresponding to the minimum percentage may be provided with learning by the learning module. In this case, the five SML classifiers with the non-duplicate category may be facilitated with learning. In an embodiment, data with the minimum confidence factor may be reviewed by the one or more data experts and the SML classifiers associated with the minimum confidence factor may analyse the reviewed data to learn and correct the prediction.

The data category determination module 221 may determine the current data to be one of duplicate data and the non-duplicate data based on the confidence factor generated by the confidence factor generating module 219. The data category determination module 221 may determine the current data to be duplicate data when the confidence factor of the duplicate data category is greater than the confidence factor of the non-duplicate data category. Similarly, the data category determination t module 221 may determine the current data to be non-duplicate data when the confidence factor of the non-duplicate data category is greater than the confidence factor of the duplicate data category. In an embodiment, once the category of the data is determined, instructions may be provided to the system to manage the redundant data. In an embodiment, the duplicate data may be deleted from the current data.

FIG. 3 show an exemplary representation for imaging data of an enterprise in accordance with some embodiments of the present disclosure.

Referring now to FIG. 3, an exemplary representation 300 for managing data of an enterprise is illustrated. The exemplary representation 300 comprises the data management system 101 connected to the data source 103₁ of the enterprise. A person skilled in the art would understand that FIG. 3 is an exemplary embodiment and the present disclosure may include plurality of data sources 103. In an embodiment, the data management system 101 may be connected to the database 107 (not shown explicitly in FIG. 3). To determine duplicity of data for managing the data of the enterprise, the data management system 101 may train the plurality of SML classifiers previously using the plurality of training datasets. For example, consider, the data management system 101 comprises twenty SML classifiers and the twenty SML classifiers are trained using four training datasets which are analysed by the one or more data experts and categorized as duplicate or non-duplicate. The four training datasets are stored in a training table 301 as shown in the FIG. 3. The training table 301 is associated with customer information of the enterprise. The customer information comprises such as, first name, last name, address, city, and state associated with the customer. For example, the training table 301 comprises master data and source data as shown in the FIG. 3. During training phase, the master data may be compared with the source data in order to determine any duplicity in the data. For instance, the fields such as, first name, last name, address, city, county, and state are compared between the master data and the source data. In an embodiment, the training data in the training table 301 may be converted from text format to numerical format to input to the SML classifiers. In an embodiment, points-of-similar score and exact-match score may be computed to generate one or more features with numerical values. In an embodiment, points-of-similar score is a value between “0” and “1”, with “0” indicating no similarity and “1” indicating exact match. In an embodiment, the points-of-similar score is computed for related columns between the master data and source data independently and stored as a feature. For example, points-of-similar score between first field, i.e. the ‘first Name’ from the master data and the “first name” from the source data is computed to input to the SML classifiers. Such score may also be computed for ‘last name’, ‘address’, ‘city’ and ‘county’ fields. Table 2 below shows scores calculated for each of the fields. The SML classifiers may be trained by analysing the scores.

TABLE 2

| First name | Last name | Address | City | Country |
|---|---|---|---|---|
| 0.2 | 0.18 | 0.24 | 1 | 0.29 |
| 0.27 | 0 | 0.2 | 0.15 | 0.17 |
| 0.91 | 1 | 0.88 | 1 | 0.24 |

In real time, the data management system 101 may receive data from the data source 103₁ associated with the enterprise to determine duplicity. The data received from the data source 103₁ is stored in a customer table 303 as shown in the FIG. 3. The customer table 303 comprises the current data and the reference data as shown in the FIG. 3. The customer table 303 is associated with the customer of the enterprise. The current data and the reference data comprises field such as, first name, last name, address, city and country. In an embodiment, the current data may be suspected to be duplicate with respect to the reference data, by the enterprise. The data management system 101 may predict the category for the current data to be one of the duplicate data and the non-duplicate data by using the twenty SML classifiers. Each of the SML classifiers may predict the category for the current data individually. For instance, consider that among twenty SML classifiers, eight SML classifiers predict the current data to be duplicate data and twelve SML classifiers predict the current data to be non-duplicate. Further, the data management system 101 may generate the confidence factor of the duplicate data category and the non-duplicate data category based on the prediction of each of the twenty SML classifiers. In the present case, the confidence factor for the duplicate data category is forty percentage and for the non-duplicate data category is sixty percentage. Thus, based on the confidence factor, the data management system 101 may determine the current data to be one of the duplicate data and the non-duplicate data. In this case, the data management system 101 determines the current data to be non-duplicate since the confidence factor for the non-duplicate category is greater than the confidence factor for the duplicate category. For instance, in first record of the current data, i.e., for customer, “Curt”, although the first name may be analysed as a short form of “Curtis”, which is the first name of the first record in the reference data. However, the address field, i.e., South Miami and North Miami are two different street addresses and there is chance of two different persons with this name staying in each of these addresses. Also, the city field for the first record in the current data is “Chap hill” and for the first record in the reference data is “Cary”, which are two different cities. Hence, the first record in the current data is determined to be non-duplicate data. Further, the SML classifiers with the prediction of duplicate category, i.e., the eight SML classifiers may be facilitated with learning to learn and improve in prediction.

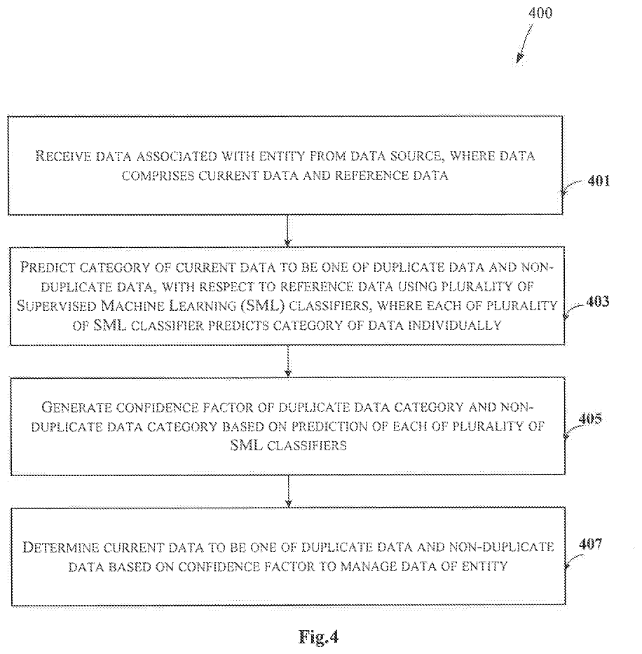

FIG. 4 illustrates a flowchart showing a method for managing data of an entity in accordance with some embodiments of present disclosure.

As illustrated in FIG. 4, the method 400 includes one or more blocks for managing data of an entity. The method 400 may be described in the general context of computer executable instructions. Generally, computer executable instructions can include routines, programs, objects, components, data structures, procedures, modules 209, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the data associated with the entity is received by the receiving module 211 from the data source of the plurality of data sources 103. The data comprises the current data and the reference data.

At block 403, the category of the current data is predicted by the category prediction module 217 to be one of, duplicate data and non-duplicate data, with respect to the reference data, using a plurality of Supervised Machine Learning (SML) classifiers. The plurality of SML classifiers predict the category of the data individually. In an embodiment, the plurality of SML classifiers are trained by the training module 213 based on the plurality of master datasets analysed by the one or more data experts as duplicate and non-duplicate.

At block 405, the confidence factor of the duplicate data category and the non-duplicate data category is generated by the confidence factor generating module 219, based on the prediction of each of the plurality of SML classifiers.

At block 407, the current data is determined by the to be one of, the duplicate data and the non-duplicate data by the data category determination module 221 based on the confidence factor to manage the data of the entity.

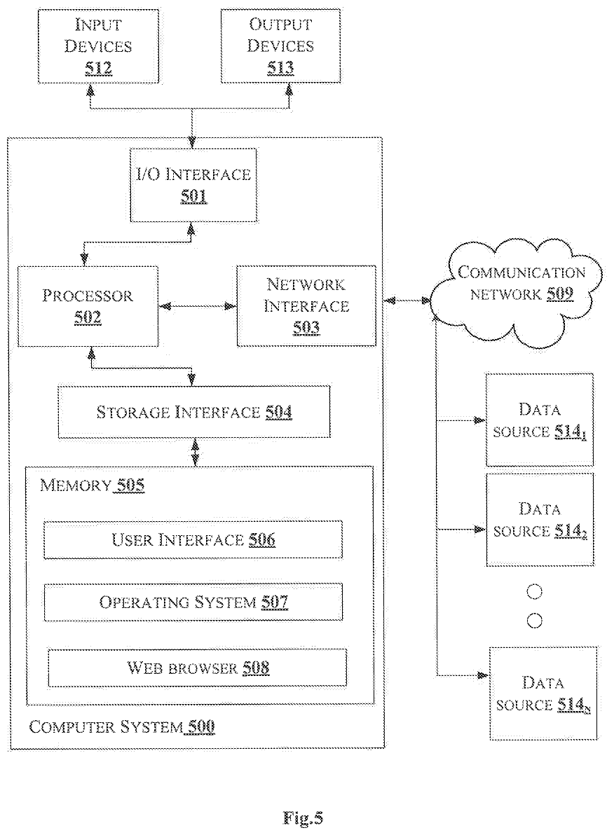

FIG. 5 illustrates a block diagram of an exemplary computer system 500 for implementing embodiments consistent with the present disclosure. In an embodiment, the computer system 500 may be used to implement the data management system 101. The computer system 500 may include a central processing unit (“CPU” or “processor”) 502. The processor 502 may include at least one data processor for managing data of an entity. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI). RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of the data management system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a data source 514₁, a data source 514₂, and a data source 514_{N}. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement a web browser 508 stored program component. The web browser 508 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBE FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIFTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM). Read-Only Memory (ROM), volatile memory, non-volatile memory, hard drives, CD ROMs, DVDs, flash drives, disks, and any other known physical storage media.

An embodiment of the present disclosure provides a system for managing data in a plurality of scenarios.

An embodiment of the present disclosure may be tuneable to specific customer needs.

An embodiment of the present disclosure facilitates flexibility in learning continuously and improving based on records reviewed by data stewards with low confidence percentage.

An embodiment of the present disclosure may unlearn based on corrections thereby improving the knowledge.

In an embodiment of the present disclosure performance for managing the data may not degrade with increase in data volume, rather confidence and knowledge improves with increase in volume.

An embodiment of the present disclosure uses distance of address field as one of the features to resolve records. For instance, if address of a current and reference entities is same, then physical distance between them is zero. Alternatively, if the address is different, physical distance between them may be other than zero. This insight on the address field is used by the plurality of SML classifiers as one of the features or attributes in making predictions.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the invention, and that the article of manufacture may include suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 100 | Environment |
| 101 | Data management system |
| 103 | Plurality of data sources |
| 105 | Communication network |
| 107 | Database |
| 109 | I/O interface |
| 111 | Memory |
| 113 | Processor |
| 200 | Data |
| 201 | Entity data |
| 203 | Confidence factor data |
| 205 | Metrics data |
| 207 | Other data |
| 209 | Modules |
| 211 | Receiving module |
| 213 | Training module |
| 215 | Evaluation module |
| 217 | Category prediction module |
| 219 | Confidence factor generating module |
| 221 | Data category determination module |
| 223 | Other modules |
| 301 | Training table |
| 303 | Customer table |
| 500 | Computer system |
| 501 | I/O interface |
| 502 | Processor |
| 503 | Network interface |
| 504 | Storage interface |
| 505 | Memory |
| 506 | User interface |
| 507 | Operating system |
| 508 | Web browser |
| 509 | Communication network |
| 512 | Input devices |
| 513 | Output devices |
| 514 | Plurality of data sources |

What is claimed is:

1. A method of managing data of an entity, the method comprising:
receiving, by a data management system, data associated with an entity from a data source, wherein the data comprises a current data and a reference data;
predicting, by the data management system, a category of the current data to be one of, duplicate data and non-duplicate data, with respect to the reference data, using a plurality of Supervised Machine Learning (SML) classifiers, wherein each of the plurality of SML classifiers predicts the category of the data individually;
generating, by the data management system, a confidence factor of the duplicate data category and the non-duplicate data category based on the prediction of each of the plurality of SML classifiers; and
determining, by the data management system, the current data to be one of, the duplicate data and the non-duplicate data based on the confidence factor to manage the data of the entity.

2. The method as claimed in claim 1 further comprising converting format of the data to a predefined format of the plurality of SML classifiers.

3. The method as claimed in claim 1, wherein the plurality of SML classifiers are trained based on a plurality of master datasets associated to the entity analysed by one or more data experts as duplicate and non-duplicate.

4. The method as claimed in claim 3 further comprising evaluating the plurality of trained SML classifiers based on one or more metrics and data exploration technique.

5. The method as claimed in claim 4, wherein the one or more metrics comprises accuracy metrics, precision metrics, recall metrics and F1-score metric which is a combination of precision and recall metrics.

6. The method as claimed in claim 1, wherein the current data is determined to be duplicate data when the confidence factor of the duplicate data category is greater than the confidence factor of the non-duplicate data category.

7. The method as claimed in claim 1, wherein the current data is determined to be non-duplicate data when the confidence factor of the non-duplicate data category is greater than the confidence factor of the duplicate data category.

8. The method as claimed in claim 1 further comprising facilitating learning for one or more SML classifiers of the plurality of SML classifiers, associated with the category of the data having a minimum confidence factor.

9. The method as claimed in claim 1 further comprising providing instructions to a system based on the determination of the current data to be one of the duplicate data and the non-duplicate data to manage redundant data.

10. A data management system for managing data of an entity, comprising:
a processor; and
a memory communicatively coupled to the processor, wherein the memory stores processor instructions, which, on execution, causes the processor to:
receive data associated with an entity from a data source, wherein the data comprises a current data and a reference data;
predict a category of the current data to be one of, duplicate data and non-duplicate data, with respect to the reference data, using a plurality of SML classifiers, wherein each of the plurality of SML classifiers predicts the category of the data individually;
generate a confidence factor of the duplicate data category and the non-duplicate data category based on the prediction of each of the plurality of SML classifiers; and
determine the current data to be one of the duplicate data and the non-duplicate data based on the confidence factor to manage the data of the entity.

11. The data management system as claimed in claim 10, wherein the processor converts format of the data to a predefined format of the plurality of SML classifiers.

12. The data management system as claimed in claim 10, wherein the processor trains the plurality of SML classifiers based on a plurality of master datasets associated to the entity, analysed by one or more data experts as duplicate and non-duplicate.

13. The data management system as claimed in claim 12, wherein the processor evaluates the plurality of trained SML classifiers based on at least one of one or more metrics and data exploration technique.

14. The data management system as claimed in claim 13, wherein the one or more metrics comprises accuracy metrics, precision metrics, recall metrics and F1-score metric which is a combination of precision and recall metrics.

15. The data management system as claimed in claim 10, wherein the processor determines the current data to be duplicate data, when the confidence factor of the duplicate data category is greater than the confidence factor of the non-duplicate data category.

16. The data management system as claimed in claim 10, wherein the processor determines the current data to be non-duplicate data when the confidence factor of the non-duplicate data category is greater than the confidence factor of the duplicate data category.

17. The data management system as claimed in claim 10, wherein the processor facilitates learning for one or more SML classifiers of the plurality of SML classifiers, associated with the category of the data having a minimum confidence factor.

18. The data management system as claimed in claim 10, wherein the processor provides instructions to a system based on the determination of the current data to be one of the duplicate data and the non-duplicate data to manage redundant data.

19. A non-transitory computer readable medium including instruction stored thereon that when processed by at least one processor cause a data management system to perform operation comprising:
receiving data associated with an entity from a data source, wherein the data comprises a current data and a reference data;
predicting a category of the current data to be one of, duplicate data and non-duplicate data, with respect to the reference data, using a plurality of Supervised Machine Learning (SML) classifiers, wherein each of the plurality of SML classifiers predicts the category of the data individually;
generating a confidence factor of the duplicate data category and the non-duplicate data category based on the prediction of each of the plurality of SML classifiers; and
determining the current data to be one of, the duplicate data and the non-duplicate data based on the confidence factor to manage the data of the entity.
